(19) United States
(12) Patent Application Publication
(10) Pub. No.: US 2007/0140819 A1
(43) Pub. Date: Jun. 21, 2007

(54) Installation and method for transferring a load between a transfer platform and a transport vehicle

(75) Inventors: Pierre Piveteau, Sainte Florence (FR); Jean Piveteau, Sainte Florence (FR)

Correspondence Address: YOUNG & THOMPSON, 745 SOUTH 23RD STREET, 2ND FLOOR, ARLINGTON, VA, 22202, US

(73) Assignee: SCIERIE PIVETEAU, Sainte Florence (FR)

(21) Appl. No.: 10/592,934

(22) PCT Filed: Mar. 16, 2005
(86) PCT No.: PCT/FR05/00625

§ 371 Date: Nov. 15, 2006

(30) Foreign Application Priority Data
Mar. 17, 2004 (FR) 0402748

(51) Int. Cl. B65F 9/00

(52) U.S. Cl. 414/373; 414/396

(57) ABSTRACT

An installation for transferring a load between a load transfer platform and, in particular, a transport vehicle. The load transfer platform includes a transfer path on which a load can be positioned by at least one load supporting transfer element. This load supporting transfer element can by axially moved along the transfer path by a motor carriage that can be coupled to the element. The carriage can be displaced in a to-and-fro manner by a transmission connected to a motor element for enabling it, during the displacement thereof, to alternately push and pull the element and the load thereof according to the transfer operations to be carried out. This installation includes at least two load supporting transfer elements and each load supporting transfer element is provided in the form of a longitudinal member that can be coupled to the carriage.

This invention relates to an installation and a process for transfer of a load, especially containerizable, between a load loading and/or unloading platform, said transfer platform, and especially a transport vehicle.

Shipping of containerized loads has developed in recent years. The loading of containers often involves a very long stage because it is difficult to access the interior of the containers. This results in poor optimization of this merchandise shipping. Currently, there is no satisfactory solution for prompt loading or respectively unloading of such containers while ensuring optimized utilization of the useful volume.

Thus, patent US 2002/085904 describes a load transfer installation that includes a load transfer platform composed of a transfer path on which a load can be positioned by way of the mobile platform shown at (18) in the figures. This platform can then be moved to be positioned on the bed of a truck. This movement is obtained by way of a carriage shown at (42). This driving carriage can be coupled to the platform via lockable arms within housings arranged in the platform (18). The carriage can thus be moved back and forth by a transmission during this motion to allow it to be in turn a pusher of the tray and of its load or a puller of this same tray and its load. The implementation of the load support transfer element in the form of a tray entails a certain number of disadvantages. In fact, the tray, due to its large surface area, must have guide elements that work with additional guide elements of the bed of the vehicle to be loaded. On the one hand, this necessitates a specific outfitting of the vehicle, and, on the other hand, it causes a loss of height from the useful load height. Moreover, this tray, in order to allow optimization of its load, should have a length corresponding to the total length of the load that is generally close to 12 meters in the case of a container. This results in an unacceptable additional economic cost at the level of the price of the tray, it being understood that the tray remains within the vehicle until the unloading.

U.S. Pat. No. 3,169,652 describes an installation whose load support transfer element is formed by a flexible sled. Again, it is necessary to have a load surface with particular properties to allow movement of the sled to the surface of the load tray, without which jamming will occur. In addition, the cost of this sled to resist tears and pulling forces remains high. Moreover, the unloading of the load is tedious because it requires coupling a coupling bar to one end of the sled of the mat type to allow unloading of the unit.

One objective of this invention is thus to suggest an installation for load transfer whose design allows preparation, concurrently, of a load intended to be transferred into a container or some other similar means of transport while enabling prompt loading of this container at one time, the preparation of all of the load concurrently making it possible to optimize filling of the container.

Another object of this invention is to propose an installation for load transfer, whose design of the load support transfer element allows one-time transfer of the entire load without specific outfitting of the receiving surface of the vehicle to be loaded and at a cost that remains economically feasible.

Another objective of this invention is to suggest an installation whose design allows equally loading or respectively unloading of a container in an extremely short time.

To do this, the object of the invention is an installation for transfer of a load, especially containerizable, between a load loading and/or unloading platform, said transfer platform, and especially a transport vehicle, said load transfer platform being composed of a transfer path on which a load, preferably containerizable, can be positioned, by way of at least one load support transfer element, this load support transfer element being axially movable along the transfer path by way of a driving carriage that can be coupled to said element, this carriage being movable back and forth by a transmission linked to a driving element to allow it, during its movements, to be in turn a pusher of said element and of its load and a puller of the same element and its load, depending on the transfer operations to be carried out, characterized in that the installation comprises at least two load support transfer elements and in that each load support transfer element is in the form of a side member that can be coupled to said carriage, each side member preferably being chosen with a length that is at least equal to the total length of the load to be transferred so as to effect the transfer at one time and to optimize loading.

Due to the presence of the transfer platform of the installation, it is possible to prepare the entire load to be transferred concurrently.

At the same time, the presence of transfer side members allows equally loading or unloading of the load into or out of the container, these transfer operations being accomplished within a very short time. Moreover, the transfer side members accompanying the load to be transferred can be reused after use of the load. For this reason, the implementation cost remains acceptably. In fact, these side members are simple to produce at low cost, including when they reach a great length. They thus allow optimization of the arrangement of the different loads on said side members while allowing transfer in a single movement.

Another object of the invention is a process for transfer of a load, in particular a containerizable load, between a load loading and/or unloading platform, said transfer platform, and especially a transport vehicle by means of an installation of the aforementioned type, characterized in that it consists, in the case of a loading operation, for example, onto the cargo bed of a vehicle, in positioning on the platform of the installation at least two transfer side members whose length is at least equal to the total length of the load to be transferred, in preparing concurrently said load on said side members, in effecting before, during or after preparation of the load all of the adjustments allowing positioning of the path delineated by the load transfer platform of the installation at the height of the cargo bed of the vehicle that is to be loaded and that is located on one end of this path of said platform, and in transferring all of the load by means of a carriage positioned on the load transfer platform, this carriage driving at the same time the load and the transfer side members to bring the assembly onto the cargo bed of the vehicle.

The invention will be better understood by reading the following description of embodiments, with reference to the attached drawings in which:

FIG. 1 shows a diagrammatic side view of an installation according to the invention in a position stowed on a truck, the installation being shown in a position in which the load is intended to be introduced into a container;

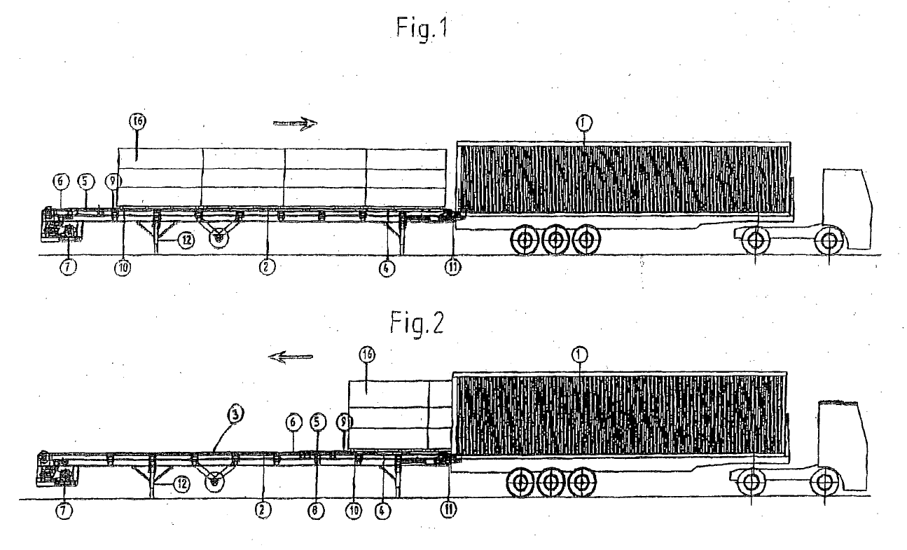

FIG. 2 diagrammatically shows a side view of an installation according to the invention in the position in which the load is intended to be removed from a container located on the cargo bed of a truck;

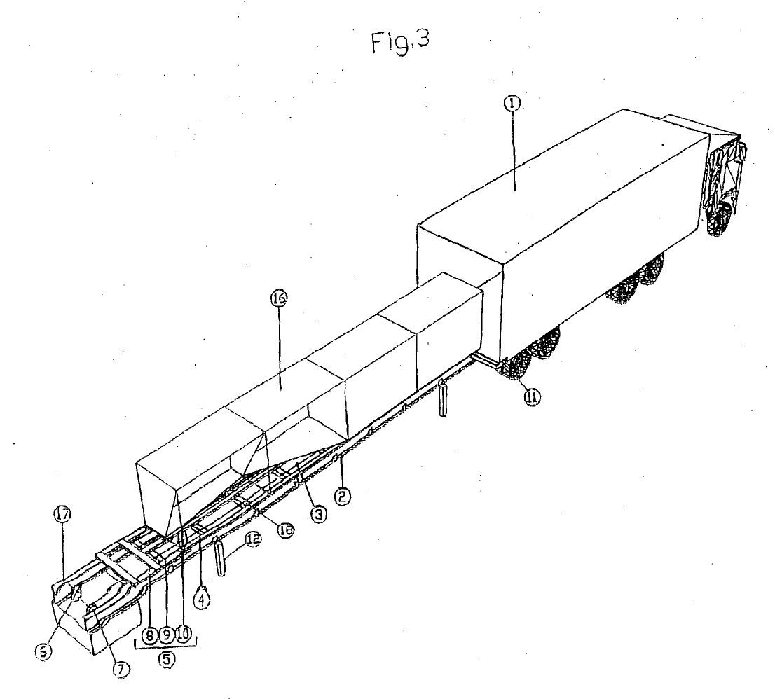

FIG. 3 shows a partial top view of an installation according to the invention in which certain elements have been shown transparently to facilitate understanding;

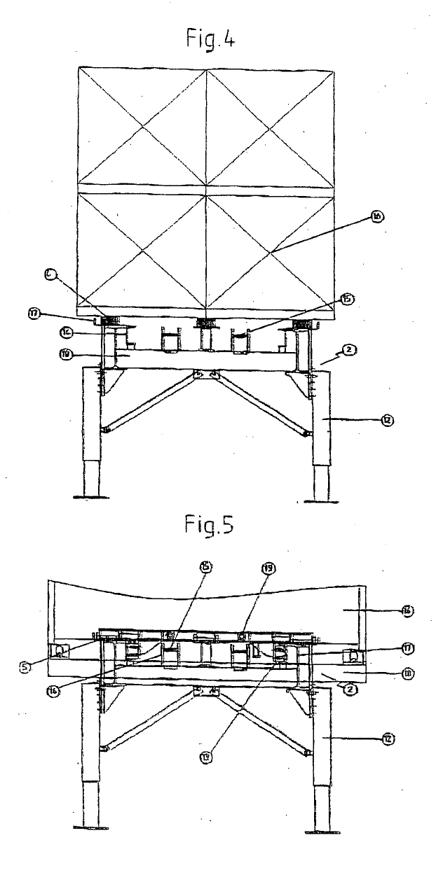

FIG. 4 shows a cutaway view of an installation according to the invention;

FIG. 5 shows another cutaway view of an installation according to the invention, the cut having been made at the level of the carriage, and

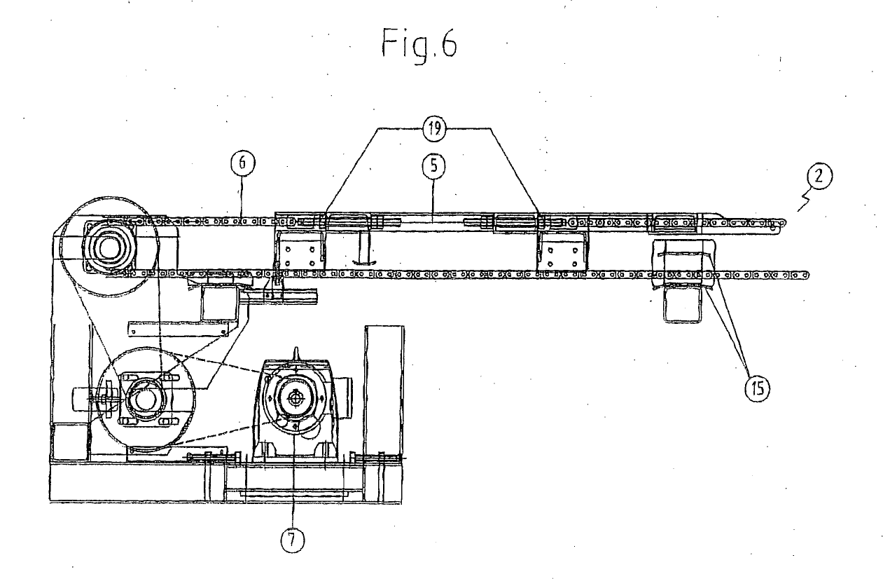

FIG. 6 shows a partial diagrammatic side view of the transmission and its driving element.

As mentioned above, the installation that is the object of the invention is designed to allow the transfer of the load between a platform 2 for loading and/or unloading of the load 16, said transfer platform, and especially a transport vehicle 1. The vehicle is defined as a truck, a ship, a rail car or any other vehicle. In the examples shown, transfer takes place between a loading platform 2 and a truck 1 whose load tray is topped with a container, the load 16 having to be transferred or respectively removed from this container. The platform 2 for transfer of the load 16 of this installation is composed of a transfer path 3 on which a load 16 can be positioned by way of rigid load support transfer elements. Characteristically of the invention, these load support elements are composed of side members 4. The side-member solution is preferred due to its simplicity, its cost, the possibility of transfer of the entire load at one time, and the absence of fittings of the receiving surface. Thus, the transfer side members 4 are interposed between the load 16 that can be composed of a block of material, wood or other elements and the surface of the top of the transfer platform 2. The transfer side members 4 are composed of glued, laminated beams in the examples shown. Their length is preferably at least equal to the length of the load to be transferred that must itself preferably cover the entire receiving surface. In the case of container loading, the length of the side members can reach at least 10 meters and is preferably close to 12 meters, this length corresponding to the total length of the platform to be loaded. These side members 4 can move axially, along the transfer path 3 set up by the transfer platform 2 via a driving carriage 5. This driving carriage 5 can be temporarily coupled to the side members 4. This carriage can, moreover, be moved back and forth by a transmission 6 linked to a driving element 7. This carriage 5 thus makes it possible, during its movements, to be in turn a pusher of the side members 4 and their load 16, for purposes of, for example, transferring the load from the loading platform 2 to the truck 1 and the container with which it is provided, or conversely to be a puller of the same side members 4 and their load 16 to allow unloading of the load located within the container with which the truck 1 is provided. These two possibilities are shown in FIGS. 1 and 2 respectively. Obviously, when the carriage is used as a pusher element for the transfer side members 4, it is not necessary to link, i.e., mechanically couple, the carriage 5 to the side members 4.

In the examples shown, especially as FIG. 3 illustrates, this carriage 5 is composed of a frame 8 provided with shafts 9 carrying, on their end, fish plates 10 that can be temporarily mounted on the ends of the transfer side members 4 to allow them to be pulled. The fish plates 10 are formed by simple metal plates that may be bent, the linkage to the side members being accomplished by screws, wedging or pins. The side members for this purpose are pre-perforated on at least one of their ends. Coupling is then accomplished in an extremely short time, without difficulty. This carriage 5 is driven to move via a continuous transmission 6, preferably a chain transmission. Thus, FIG. 5 illustrates the points 19 for attachment of the chain to the carriage. The driving element 7 is composed of a driving geared motor coupled by way of a continuous transmission to an intermediate shaft, itself coupled again by way of another continuous transmission to rollers around which the chain turns in one direction or the other according to the direction in which the geared motor is driven into rotation. The chain is thus fixed, as shown in FIG. 6, by one of its ends on one side of the carriage and by its other end on the opposite side of said carriage to allow, during driving in the first direction of the chain that describes a loop, the carriage to be moved away from the vehicle, and, conversely, during driving of the motor 7 into rotation in the other direction, the movement of the chain and consequently of the carriage 5 in the direction of driving the carriage 5 closer to the vehicle 1. To facilitate movement of this carriage 5, the latter is equipped with pads 13 or guide rollers intended to be inserted within continuous axial bearings 14 arranged in the platform 2. This transfer platform 2 is actually formed by longitudinal beams 17 interconnected by crosspieces 18 to form an openwork load support plane. In the examples shown, this platform 2 comprises at least three parallel longitudinal beams 17, each comprising a support surface and possibly a guide surface of one transfer side member 4. Thus, two beams are made in the form of an I beam whose top surface is provided with an external peripheral flange to comprise a guide rail of the transfer side member 4. The central beam delineates an unguided support surface of the transfer side member 4. Axial support bearings 15 of the transmission 6 described above are provided between the beams 17.

The platform 2 is again, if necessary, equipped with feet 12 that can be adjusted in height to allow the leveling of the load support plane of the platform relative to the floor of the container carried by the vehicle 1. This platform can likewise be equipped with wheels so as to be made in the form of a rolling platform allowing its movement as a function of the transfer operations to be carried out. Obviously, it remains free on its sides so that the loading is always easy.

To make it possible for these transfer operations to be risk-free, on one of the ends of the transfer platform 2 there is a fastening device 11 for integration of the installation with the vehicle 1 to be loaded.

The transfer operations are carried out as follows: the installation is placed in a predetermined location; the vehicle 1 to be loaded, of which the load tray is provided with a container, is positioned at one of the ends of the platform 2 to which it is fastened by a suitable fastening device 11 that generally operates by wedging. At the same time, the position of the platform 2 is adjusted in height to allow leveling of the path 3 delineated by the platform 2 with the floor of the container to be loaded or unloaded. In the case of an operation of loading this container, the load 16 to be transferred has already been prepared concurrently on the transfer platform 2. For this purpose, transfer side members 4 have then been positioned on the platform 2. The load 16 is then placed on top of these transfer side members 4, of which the calculation has been optimized to ensure maximum filling of the container.

When all of the adjustments have been made, the carriage 5, positioned on the platform, is driven into motion in the direction of the arrow shown in FIG. 1 to push the load and the transfer side members 4 and to bring this assembly within the container. This loading operation can thus be done extremely quickly.

Conversely, during an operation of unloading a container carried by a truck, the same preliminary operations are carried out, i.e., attaching the fastening device and adjusting the height of the platform relative to the floor of the container to be unloaded. The carriage is then moved into the vicinity of the container and is coupled via fish plates 10 to the transfer side members 4. This coupling operation is generally carried out using two screws or the like. Once the carriage 5 is coupled to the side members 4, it is then enough to move the carriage 5 in the direction of the arrow shown in FIG. 2 to remove the entire load supported by the transfer side members 4 from the container. Again, this operation can be done extremely quickly. The load 16 is then placed on standby on the platform 2 until this load is unloaded.

Such an installation leads to a major time savings during loading or respectively unloading operations that can be done within an extremely short time. At the same time, the loading of containers is optimized, the arrangement of the load within the container can be calculated in advance and prepared so as to optimize its filling.

1. Installation for transfer of a load, especially containerizable, between a platform (2) for loading and/or unloading of a load (16), said transfer platform, and especially a transport vehicle (1), said load transfer platform (2) being composed of a transfer path (3) on which a load (16), preferably containerizable, can be positioned by way of at least one load support transfer element, this load support transfer element being axially movable along the transfer path (3) by way of a driving carriage (5) that can be coupled to said element, this carriage (5) being movable back and forth by a transmission (6) linked to a driving element (7) to allow it, during its movement, to be in turn a pusher of said element and of its load (16) and a puller of the same element and its load, depending on the transfer operations to be carried out, characterized in that the installation comprises at least two load support transfer elements and in that each load support transfer element is in the form of a side member (4) that can be coupled to said carriage, each side member (4) preferably being chosen with a length that is at least equal to the total length of the load (16) to be transferred so as to effect the transfer at one time and to optimize loading.

2. Installation according to claim 1, wherein the carriage (5) is composed of a frame (8) provided with shafts (9) carrying, on their end, fish plates (10) that can be temporarily mounted on the ends of the transfer side members (4).

3. Installation according to claim 1, wherein on one of the ends of the transfer platform (2), there is a fastening device (11) for integration of the installation with the vehicle (1) to be loaded.

4. Installation according to claim 1, wherein the platform (2) is formed by longitudinal beams (17) interconnected by crosspieces (18) to form an openwork load support plane.

5. Installation according to claim 4, wherein the platform (2) comprises at least three parallel longitudinal beams (17), each comprising a support surface and possibly guide surface of one transfer side member (4).

6. Installation according to claim 5, wherein axial support bearings (15) of the transmission (6) are provided between said beams (17).

7. Installation according to claim 1, wherein the platform (2) is equipped with feet (12) that can be adjusted in height and is optionally made in the form of a rolling platform.

8. Installation according to claim 1, wherein the carriage (5) is driven into motion by way of a continuous transmission (6), preferably a chain transmission.

9. Installation according to claim 1, wherein the carriage (5) is equipped with pads (13) or guide rollers intended to be inserted within continuous axial bearings (14) arranged in said platform (2).

10. Installation according to claim 1, wherein the transfer side members (4) are composed of glued, laminated beams.

11. Process for transfer of a load, especially containerizable, between a platform (2) for loading and/or unloading of a load (16), said transfer platform, and especially a transport vehicle (1), by way of an installation according to claim 1, wherein in the case of an operation of loading, for example onto the cargo bed of a vehicle, it consists in positioning on the platform (2) of this installation at least two transfer side rails (4) whose length is at least equal to the total length of the load to be transferred, in preparing concurrently said load on said side members, in effecting before, during or after preparation of the load all of the adjustments allowing positioning of the path (3) delineated by the load transfer platform (2) of the installation at the height of the cargo bed of the vehicle that is to be loaded and that is located on one end of said path of said platform, and in transferring all of the load by means of a carriage (5) positioned on the load transfer platform (2), this carriage (5) driving at the same time the load and the transfer side members (4) to bring the assembly onto the cargo bed of the vehicle.
